(19) United States
(12) Patent Application Publication
(10) Pub. No.: US 2006/0163390 A1
(43) Pub. Date: Jul. 27, 2006

(54) Fuel injection valve

(76) Inventors: Wolfgang-Manfred Ruehle, Ditzingen (DE); Matthias Boee, Woshwestheim (DE); Norbert Keim, Loechgau (DE)

Correspondence Address: KENYON & KENYON LLP, ONE BROADWAY, NEW YORK, NY, 10004, US

(21) Appl. No.: 10/537,016

(22) PCT Filed: Aug. 7, 2003
(86) PCT No.: PCT/DE03/02656

§ 371 Date: Mar. 1, 2006

(30) Foreign Application Priority Data
Dec. 5, 2002 (DE) 102 56 948.7

(51) Int. Cl. F02M 51/00

(52) U.S. Cl. 239/585.1; 239/585.4; 239/585.5

(57) ABSTRACT

A fuel injector, especially for directly injecting fuel into a combustion chamber of an internal combustion engine, having a valve needle which, at its spray-discharge end, has a valve-closure member that cooperates with a valve-seat surface formed on a valve-seat member to form a sealing seat, and having at least one spray orifice provided downstream from the sealing seat, and an armature that acts on the valve needle. The armature is positioned so as to be axially movable on the valve needle between a first limiting stop situated on the valve needle and a second limiting stop, and is hydraulically damped at the first limiting stop by a pressure medium.

### FIELD OF THE INVENTION

The present invention relates to a fuel injector.

### BACKGROUND INFORMATION

German Patent Application DE 101 08 974 A1 describes, for example, a fuel injector in which a solenoid armature acts on a valve needle, that has a valve-closure member at its spray-discharge end and cooperates with a valve-seat surface to form a sealing seat, the solenoid armature being movably guided on the valve needle between a first limiting stop of a first stop member and a second limiting stop formed on a second stop member, with clearance that corresponds to the width of a gap. The gap located between the limiting stops and the solenoid armature, along with the axially freely movable solenoid armature effect a decoupling of the inert masses of the solenoid armature, on the one hand, and of the valve needle and the valve closure member, on the other hand, since the solenoid armature can be accelerated by the action of the magnetic field force, initially without the valve needle. The metering dynamics of the fuel injector is thereby improved. In the quiescent condition, the solenoid armature is pressed by a spring located between the first limiting member and the armature against the second limiting member, an intermediate ring being interposed. The intermediate ring, made of an elastomer, for example, acts during closing of the fuel injector as a damper against armature bounces produced by the solenoid armature which lags behind the valve needle during the closing operation, and also has the effect of shortening the vibrations induced during the process. It likewise acts as a damping element against the bounce which occurs during opening and is caused by the valve needle that lags behind the solenoid armature when the second stop member strikes the solenoid armature. Another purpose of the intermediate ring is to reduce the path covered by the valve needle in the solenoid armature after it reaches the top solenoid-armature limiting stop. The intermediate ring shortens the time required by the fuel injector to assume a stable and vibration-free condition after the solenoid armature pulls in and, respectively the sealing seat closes, from this precisely definable condition, it again being possible to actuate the fuel injector.

A drawback associated with the above described fuel injector is, in particular, that only inadequate damping of the impact between the solenoid armature and the stop member is possible by using an intermediate ring made of elastomer, for example, especially at a very high actuating frequency or very short opening times. Thus, at high actuating frequencies, it is no longer possible to precisely meter fuel during one injection event, since the not yet attenuated vibrations have an unacceptable influence on the switching operations and can lead to uncontrollable variations in the actuating times, it being possible for different actuating times to occur disadvantageously between two successive actuations. As a result, it is also not possible to precisely determine the specific injection quantities.

Another drawback is due to the fluctuating damping properties of the elastic intermediate ring. This has the effect of increasing the minimum interval possible between two successive injection events and, respectively, the minimum possible opening time of the fuel injector.

It is also disadvantageous that the intermediate ring constitutes an additional component and complicates the manufacture of the fuel injector.

### SUMMARY

In contrast, a fuel injector according to an example embodiment of the present invention may have the advantage that the hydraulic damping measures between the solenoid armature and the valve needle and, respectively, between the solenoid armature and the armature stops make it possible for the occurring vibrations to be attenuated more quickly and for the paths required for that purpose to be kept shorter. In this way, the quantity of fuel injected per injection event, which is precisely reproducible to a minimal extent, may, in particular, be further reduced, the deviation in the quantity injected between the injection events and among fuel injectors of the same type likewise being minimized. As a result, the switching interval between two injections may be clearly reduced, for example from 2 ms to less than 1 ms.

The wear and the susceptibility to faults are greatly reduced by omitting the intermediate ring and alleviating load on the stop surfaces. The outlay required for manufacturing is thereby reduced.

One first example embodiment of the fuel injector according to the present invention provides for fuel, in particular diesel fuel or gasoline, to be used as a pressure medium via which the first limiting stop coacts hydraulically with the armature. This eliminates the need for a special pressure medium, and the manufacture of the fuel injector is thereby simplified.

In another example embodiment, the second limiting stop is fixed nonadjustably to the valve needle or to an adjusting disk. This enables the play required for the axial motion of the armature to be easily adjusted in a precise, simple and lasting manner.

It is also advantageous if the first limiting stop, on its side facing the armature, has a first recess, and/or the armature on its side facing the first limiting stop has a second recess. In this manner, hydraulically effective cavities are able to be simply produced, which each cooperate with the opposing component.

It is also advantageous for the recesses to be formed in single and multiple stages since this enables the hydraulic effectiveness to be easily adjusted.

If, in another example embodiment of the fuel injector according to the present invention, the first and/or the second recess is limited by the valve needle, then the manufacture of the recesses is simplified, for example, since they may be collectively produced, in particular, by one simple bore.

It may also be advantageous to place a plurality of first and/or second recesses in the first limiting stop and in the armature, respectively. This enables the hydraulic effectiveness, in particular, to be easily controlled. In addition, it is easier to adapt the positioning and the dimensions of the recesses to the spatial and hydraulic conditions.

In another example embodiment of the fuel injector according to the present invention, the first limiting stop engages in the second recess situated in the armature, and/or the armature engages in the first recess situated in the first limiting stop. As a result, the reciprocal hydraulic action between the armature and the first limiting stop is easier to adjust.

In another example embodiment, the armature, together with the first recess, and/or the first limiting stop, together with the second recess, form at least one chamber having at least one throttling point. This enables the hydraulic action between the armature and the first limiting stop to be further intensified and advantageously influenced in its time characteristic.

It may also be advantageous if the chamber to be partially bounded by the valve needle since this simplifies the manufacture of the chamber, in particular.

If, in addition, the first and/or the second recess have a circular or annular design, then, quite advantageously, they may be manufactured simply, precisely and inexpensively.

### BRIEF DESCRIPTION OF THE DRAWINGS

Exemplary embodiments of the present invention are shown in a simplified figures, and are explained in greater detail in the following description.

FIG. 1 shows a schematic section through a fuel injector.

FIG. 2 shows an enlarged, schematically illustrated section through a first exemplary embodiment according to the present invention of fuel injector 1, in the area of armature 20.

FIG. 3 shows an enlarged, schematically illustrated section through a second exemplary embodiment according to the present invention of fuel injector 1, in the area of armature 20.

FIG. 4 shows an enlarged, schematically illustrated section through a third exemplary embodiment according to the present invention of fuel injector 1, in the area of armature 20.

### DETAILED DESCRIPTION OF EXAMPLE EMBODIMENTS

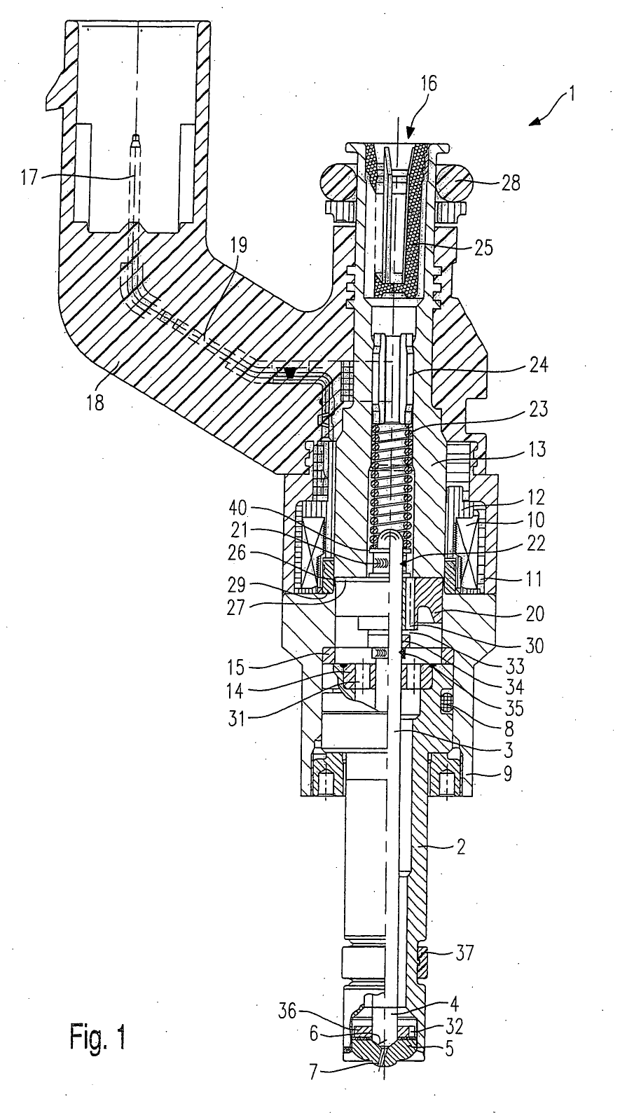

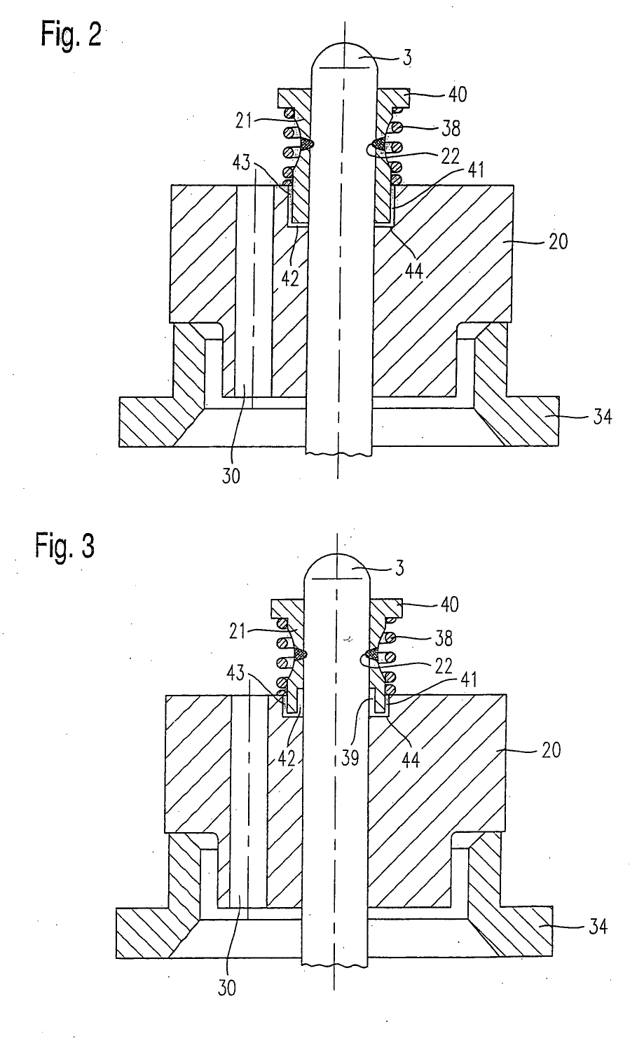

An exemplary embodiment of the present invention is described exemplarily in the following. In this context, corresponding components are provided with the same reference numerals in all of the figures. However, before going into detail about the exemplary embodiments of the present invention with reference to FIGS. 2 through 4, to clarify the measures according to the present invention, a fuel injector of the species is first briefly described with reference to FIG. 1, in accordance with the related art, and with respect to its essential components.

A fuel injector 1 illustrated in FIG. 1 is designed in the form of a high-pressure fuel injector 1 for fuel-injection systems of mixture-compressing internal combustion engines having externally supplied ignition. Fuel injector 1 is particularly suited for the direct injection of fuel into a combustion chamber (not illustrated) of an internal combustion engine.

Fuel injector 1 is composed of an injection-nozzle body 2 in which a valve needle 3 is positioned. Valve needle 3 is mechanically linked to a valve-closure member 4, which cooperates with a valve-seat surface 6 disposed on a valve-seat member 5, to form a sealing seat. In the exemplary embodiment, fuel injector 1 is an inwardly opening fuel injector 1, which has a spray orifice 7. Nozzle body 2 is sealed by a seal 8 against an external pole 9 of a solenoid coil 10. Solenoid coil 10 is encapsulated in a coil housing 11 and wound on a coil brace 12, which rests against an internal pole 13 of solenoid coil 10. Internal pole 13 and external pole 9 are separated from one another by a constriction 26 and are interconnected by a non-ferromagnetic connecting part 29. Solenoid coil 10 is energized via a line 19 by an electric current, which may be supplied via an electrical plug contact 17. Plug contact 17 is enclosed by plastic coating 18, which is extrudable onto internal pole 13.

Valve needle 3 is guided in a valve-needle guide 14, which is disk-shaped. A paired adjusting disk 15 is used to adjust the valve lift. An armature 20 is situated on the other side of adjusting disk 15. It is connected by force-locking via a first limiting stop 21 to valve needle 3, which is joined by a first joint 22 in the form of a weld to first limiting stop 21. Braced against first limiting stop 21 is a return spring 23 which, in the present design of fuel injector 1, is prestressed by a sleeve 24.

Fuel channels 30, 31 and 32 run in valve-needle guide 14, in armature 20 and on a guide element 36. The fuel is supplied via a central fuel feed 16 and filtered by a filter element 25. Fuel injector 1 is sealed by a seal 28 against a fuel distributor (not shown further) and by another seal 37 against a cylinder head (not shown further).

On the spray-discharge side of armature 20, between armature 20 and a second limiting stop 34, a gap 33 is provided which is able to accommodate an annular damping element (not shown) of elastomeric material. Armature 20 is guided so as to be axially movable on valve needle 3 between second limiting stop 34 and first limiting stop 21. In this exemplary embodiment of a fuel injector 1, second limiting stop 34 is joined via a second joint 35 in the form of a weld to valve needle 3.

In the quiescent state of fuel injector 1, return spring 23 acts on armature 20 against its direction of lift in such a way that valve-closure member 4 is held in sealing contact on valve-seat surface 6. In the process, gap 33 is closed, i.e., armature 20 and second limiting stop 34 contact one another, provided that there is no interposed annular damping element. When gap 33 is closed, between first limiting stop 21 and armature 20, an armature free path 44 (not shown in greater detail in FIGS. 2 and 3) is additionally formed, whose width in this state corresponds to the maximum width of gap 33. In response to its excitation, solenoid coil 10 generates a magnetic field which moves armature 20 in the lift direction, counter to the spring force of return spring 23, the lift being preset by a working gap 27 occurring in the rest position, between internal pole 12 and armature 20. At the same time, a spring element 38 illustrated in FIGS. 2 through 4, which engages on first limiting stop 21 and is braced against armature 20, is further tensioned, in the rest position, pressing armature 20 with preloading against second limiting stop 34 and being thereby braced against a shoulder 40 formed on first limiting stop 21.

Return spring 23 is also braced against shoulder 40, shoulder 40 being configured on the side of limiting stop 21 facing away from armature 20. Spring element 38 depicted in FIGS. 2 through 4 is also referred to as an armature free-path spring. After running through armature free path 44 shown in FIGS. 2 through 4, armature 20 carries along first limiting stop 21, which is welded to valve needle 3, likewise in the lift direction. Valve-closure member 4, which is operatively connected to valve needle 3, lifts off from valve seat surface 6, and fuel carried over fuel channels 30 through 32 is spray-discharged through spray orifice 7.

In response to the coil current being switched off and a sufficiently decayed magnetic field, armature 20 falls away from internal pole 13 under the pressure of return spring 23, with the result that first limiting stop 21, which is connected to valve needle 3, is moved counter to the lift direction. Valve needle 3 is thereby moved in the same direction, causing valve-closure member 4 to set down on valve seat surface 6 and fuel injector 1 to be closed.

FIG. 2 schematically illustrates an enlarged section through a first exemplary embodiment according to the present invention of fuel injector 1 illustrated in FIG. 1, in the area of armature 20. FIG. 2 shows fuel injector 1 in the quiescent state given a closed sealing seat. Clearly visible in this FIG. 2 is spring element 38, which, in the illustrated state, presses armature 20 against second limiting stop 34, which, in this exemplary embodiment, is connected to adjusting disk 15, for example. In this state, armature free path 44 is at its maximum. First limiting stop 21 engages in a stepped second recess 41 formed on armature 20 and partially bounded by valve needle 3.

On the spray-discharge end of second recess 41, a chamber 42 is formed by the engagement of first limiting stop 21 into second recess 41. Between chamber 42 and the spray discharge-remote side of armature 20 circumflowed with fuel, a throttling point 43 is simultaneously formed, which, in this exemplary embodiment, runs in parallel to the longitudinal axis of valve needle 3 between armature 20 and the part of first limiting stop 21 that engages in recess 41. The width and thus a portion of the hydraulic action of throttling point 43 is determined, in particular, by the inner diameter of second recess 41 as well as the outer diameter of first limiting stop 21 engaging in second recess 41.

The operating principle is as follows:

Starting out from the quiescent state depicted in FIG. 2, to open fuel injector 1, armature 20 is moved, for example, by electromagnetic forces in the lift direction. Since the action of force of return spring 23 is greater than that of spring element 38, armature 20 initially moves freely in the lift direction, without taking along valve needle 3, and generates kinetic energy. After traversing armature free path 44, thus when the end of first limiting stop 21 facing armature 20 contacts armature 20 and, respectively, second recess 41, armature 20 takes along first limiting stop 21 and thus valve needle 3 in the lift direction until armature 20 has traversed the path predefined by working gap 27 and strikes internal pole 13.

However, because of its own kinetic energy, valve needle 3 initially continues to move in the lift direction, in opposition to the action of force of return spring 23, a negative pressure thereby forming in chamber 42, since fuel is not able to flow in behind it quickly enough through throttling point 42. This negative pressure additionally counteracts the motion of valve needle 3 in the lift direction and thereby shortens the path covered by valve needle 3 after armature 20 strikes the internal pole. This path is also described as a tunneling path. As a result, the kinetic energy generated by valve needle 3 due to the action of force of return spring 23 during motion counter to the lift direction is reduced, and the danger of armature 20 lifting off from internal pole 13 is also minimized. In addition, the fuel that has flowed through throttling point 43 into chamber 42 provides for a damped motion of valve needle 3 counter to the lift direction, thereby further lessening the danger of armature 20 lifting off from internal pole 13.

To close fuel injector 1, the magnetic circuit is interrupted, and armature 20 detaches itself from internal pole 13. At this point, in response to the action of force of return spring 23, first limiting stop 21, valve needle 3, and armature 20 move counter to the lift direction. Valve needle 3, with its valve-closure member 4, then sets itself down on valve seat surface 6. Armature 20, which is axially freely movable on valve needle 3, continues to move along armature free path 44, until it strikes second limiting stop 34. The thereby generated negative pressure in chamber 42 decelerates armature 20 as it rushes through armature free path 44. This lessens the repercussive effect of the impulse on armature 20 when it strikes second limiting stop 34. In addition, the vibration initiated by the impulse is damped by the hydraulic damping effect of chamber 42 and of throttling point 43, and is shortened in time, as well as decreased in amplitude. As a result, after an only short period of time, fuel injector 1 is again able to be actuated out of its vibrationless and stable condition, making possible precisely definable and precisely reproducible injection quantities, even at very short actuating intervals.

FIG. 3 schematically illustrates an enlarged section through a second exemplary embodiment according to the present invention in the area of armature 20, that is similar to the first exemplary embodiment of FIG. 2. In contrast to the first exemplary embodiment of FIG. 2, on its side facing the armature 20, first limiting stop 21 also has a first recess 39. The thereby enlarged chamber 42 makes it advantageously possible for the hydraulic properties to be easily adjusted.

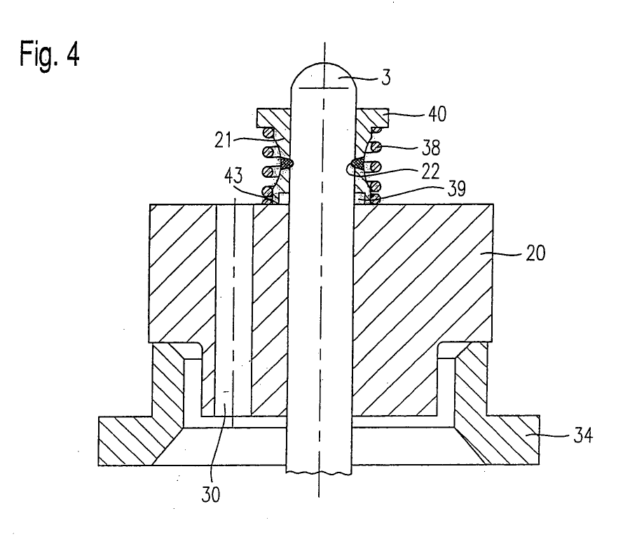

FIG. 4 schematically illustrates an enlarged section through a third exemplary embodiment according to the present invention in the area of armature 20, that is similar to the first exemplary embodiment of FIG. 2. In contrast to the first exemplary embodiment of FIG. 2, a first recess 39 is placed only in first limiting stop 21. Throttling point 43 is positioned between the end of first limiting stop 21 facing armature 20 and the end of armature 20 facing first limiting stop 21. This specific embodiment is especially well suited for fuel injectors 1 which have a substantial amount of available, radially extending space in the area of armature 20, since the damping effect is adjusted, in particular, over the length of throttling point 43 running radially in this exemplary embodiment. The outlay for production engineering is thereby advantageously reduced.

The present invention is not limited to the exemplary embodiments illustrated here and is also applicable, for instance, to outwardly opening fuel injectors.

1-11. (canceled)

12. A fuel injector for directly injecting fuel into a combustion chamber of an internal combustion engine, comprising:
a valve needle having a spray-discharge end, the valve needle having, at the spray discharge end, a valve-closure member that cooperates with a valve-seat surface, formed on a valve-seat member, to form a sealing seat;
at least one spray orifice provided downstream from the sealing seat; and
an armature that acts on the valve needle, the armature being positioned so as to be axially movable on the valve needle between a first limiting stop situated on the valve needle and a second limiting stop, wherein the armature is hydraulically damped at the first limiting stop by a pressure medium.

13. The fuel injector as recited in claim 12, wherein the pressure medium is fuel.

14. The fuel injector as recited in claim 13, wherein the fuel is one of gasoline and diesel fuel.

15. The fuel injector as recited in claim 12, wherein the second limiting stop is one of: i) fixed nonadjustably to the valve needle, ii) fixed nonadjustably to an adjusting disk, or iii) fixed immovably with respect to a housing of the fuel injector.

16. The fuel injector as recited in one claim 12, wherein, at least one of: i) on a side facing the armature, the first limiting stop has a first recess, and ii) the armature has, on a side facing the first limiting stop, a second recess.

17. The fuel injector as recited in claim 16, wherein at least one of the first recess and the second recess are formed in single or multiple stages.

18. The fuel injector as recited in claim 16, wherein at least one of the first recess and the second recess are partially bounded by the valve needle.

19. The fuel injector as recited in claim 16, wherein at least one of: i) the first limiting stop has a plurality of first recesses, and ii) the armature has a plurality of second recesses.

20. The fuel injector as recited in claim 16, wherein at least one of: i) the first limiting stop engages in the second recess situated in the armature, and ii) the armature engages in the first recess situated in the first limiting stop.

21. The fuel injector as recited in claim 16, wherein at least one of: i) the armature, together with the first recess, forms at least one chamber having at least one throttling point, and ii) the first limiting stop, together with the second recess forms the at least one chamber having the at least one throttling point.

22. The fuel injector as recited in claim 21, wherein the chamber is partially bounded by the valve needle.

23. The fuel injector as recited in claim 16, wherein at least one of the first recess and the second recess, have a circular or annular design.
